(19) United States
(12) Patent Application Publication
(10) Pub. No.: US 2016/0036998 A1
(43) Pub. Date: Feb. 4, 2016

(54) IMAGE PROCESSING APPARATUS AND SYSTEM FOR CONTROLLING PROCESSING FOR WRITING CONFIGURATION DATA TO PARTIAL RECONFIGURATION AREA, AND INFORMATION PROCESSING METHOD

(71) Applicant: CANON KABUSHIKI KAISHA, Tokyo (JP)

(72) Inventor: Junichi Goda, Kashiwa-shi (JP)

(21) Appl. No.: 14/813,731

(22) Filed: Jul. 30, 2015

(30) Foreign Application Priority Data
Aug. 4, 2014 (JP) 2014-158700

(51) Int. Cl. H04N 1/00

(52) U.S. Cl. CPC H04N 1/0097; H04N 1/00952; H04N 2201/0094

(57) ABSTRACT

An image processing apparatus includes an identification unit configured to identify a circuit function required to execute a job, a reading unit configured to read use state information of partial reconfiguration unit areas, a determination unit configured to determine an unused partial reconfiguration unit area as a writing destination based on the use state information read by the reading unit, a selection unit configured to select configuration data based on both the circuit function identified by the identification unit and the partial reconfiguration unit area determined as a writing destination by the determination unit, and a control unit configured to control processing for writing the configuration data selected by the selection unit to the partial reconfiguration unit area determined as a writing destination.

### BACKGROUND OF THE INVENTION

1. Field of the Invention

The present invention relates to an image processing apparatus and a system for controlling processing for writing configuration data to a partial reconfiguration area, and an information processing method.

2. Description of the Related Art

Reconfigurable circuits such as a Programmable Logic Device (PLD) and a Field Programmable Gate Array (FPGA) are well known for a changeable internal logical circuit configuration. Generally, the PLD and the FPGA change an internal logical block by writing logical circuit configuration information stored in a nonvolatile memory such as a read only memory (ROM) to a configuration memory (internal volatile memory) when power is turned ON. The information in the configuration memory is cleared when power is turned OFF. Therefore, it is necessary to rewrite logical circuit configuration information to the configuration memory each time power is turned ON. A method for configuring hardware resources only once in this way is referred to as a static reconfiguration. On the other hand, reconfigurable circuits in which the logical circuit configuration can be changed during operation have been developed. A method for changing logical circuits during operation is referred to as a dynamic reconfiguration.

A certain type of FPGA is able to rewrite only a specific area instead of rewriting an entire chip. A method for partially rewriting logical circuits in this way is referred to as a partial reconfiguration. In particular, performing the partial reconfiguration without deactivating other circuits currently operating is referred to as a dynamic partial reconfiguration.

In the dynamic partial reconfiguration, instead of rewriting the entire configuration memory at the time of the dynamic reconfiguration, rewriting only a part of the configuration memory area enables achieving the partial reconfiguration on logical blocks in the FPGA.

The use of such a dynamic partial reconfiguration technique enables selectively implementing a plurality of circuits in one area. Therefore, in the case of hardware resources, logical partitioning and multiplexing are performed to enable changing functions implemented by logical blocks. As a result, it becomes possible, by using few hardware resources, to flexibly implement various functions according to usages while maintaining hardware-based high calculation performance.

In the dynamic partial reconfiguration, to perform a desired function on a partially reconfigured circuit, it is necessary to prepare configuration data suitable for a partially reconfigurable area. For example, Japanese Patent Application Laid-Open No. 2000-252814 discusses a technique for implementing a reconfiguration by storing different pieces of configuration data for a plurality of partially reconfigurable areas for each function in a storage device, confirming the size of a reconfigurable free space, and selecting configuration data which suits the size of the free space.

Recent image processing apparatuses such as multi function printers (MFPs) are capable of selecting and performing a plurality of pieces of processing (a copy job, a print job, a SEND job, etc.) in response to a request from a user. Image processing corresponding to each piece of processing of an MFP is implemented by hardware or software. When a reconfigurable circuit such as an FPGA is applied as image processing hardware of an image processing apparatus, the configuration can be dynamically and partially changed for each of the above-described functions. As a result, various image processing functions can be implemented by using few hardware resources.

However, if another reconfigured circuit is written to a reconfigurable area where an existing reconfigured circuit is currently operating, the existing reconfigured circuit currently operating is overwritten by the another reconfigured circuit, possibly disabling a function currently being processed.

### SUMMARY OF THE INVENTION

The present invention is directed to enabling the use of a partial reconfiguration function without suspending a function currently being processed.

According to an aspect of the present invention, an image processing apparatus includes an identification unit configured to identify a circuit function required to execute a job, a reading unit configured to read use state information of partial reconfiguration unit areas, a determination unit configured to determine an unused partial reconfiguration unit area as a writing destination based on the use state information read by the reading unit, a selection unit configured to select configuration data based on both the circuit function identified by the identification unit and the partial reconfiguration unit area determined as a writing destination by the determination unit, and a control unit configured to control processing for writing the configuration data selected by the selection unit to the partial reconfiguration unit area determined as a writing destination.

Further features of the present invention will become apparent from the following description of exemplary embodiments with reference to the attached drawings.

### BRIEF DESCRIPTION OF THE DRAWINGS

FIG. 1 illustrates an example of a hardware configuration of an image processing apparatus.

FIG. 2 illustrates a configuration particularly related to a partial reconfiguration in the image processing apparatus.

FIG. 3 illustrates examples of configuration data.

FIGS. 4A, 4B, and 4C illustrate the contents of a partial reconfiguration (PR) management table and usage statuses in a Field Programmable Gate Array (FPGA).

FIG. 5 is a flowchart illustrating an example of information processing by the image processing apparatus.

FIGS. 6A, 6B, 6C, 6D, 6E, and 6F illustrate statuses in the FPGA and the contents of the PR management table.

FIG. 7 illustrates examples of a system configuration and a hardware configuration.

FIG. 8 illustrates an example of an area for managing a usage status.

FIG. 9 illustrates examples of configuration data.

FIG. 10 is a flowchart illustrating an example of information processing by the image processing apparatus.

FIGS. 11A, 11B, 11C, and 11D illustrate FPGA statuses.

### DESCRIPTION OF THE EMBODIMENTS

Exemplary embodiments of the present invention will be described below with reference to the accompanying drawings.

### [Configuration of Image Processing Apparatus]

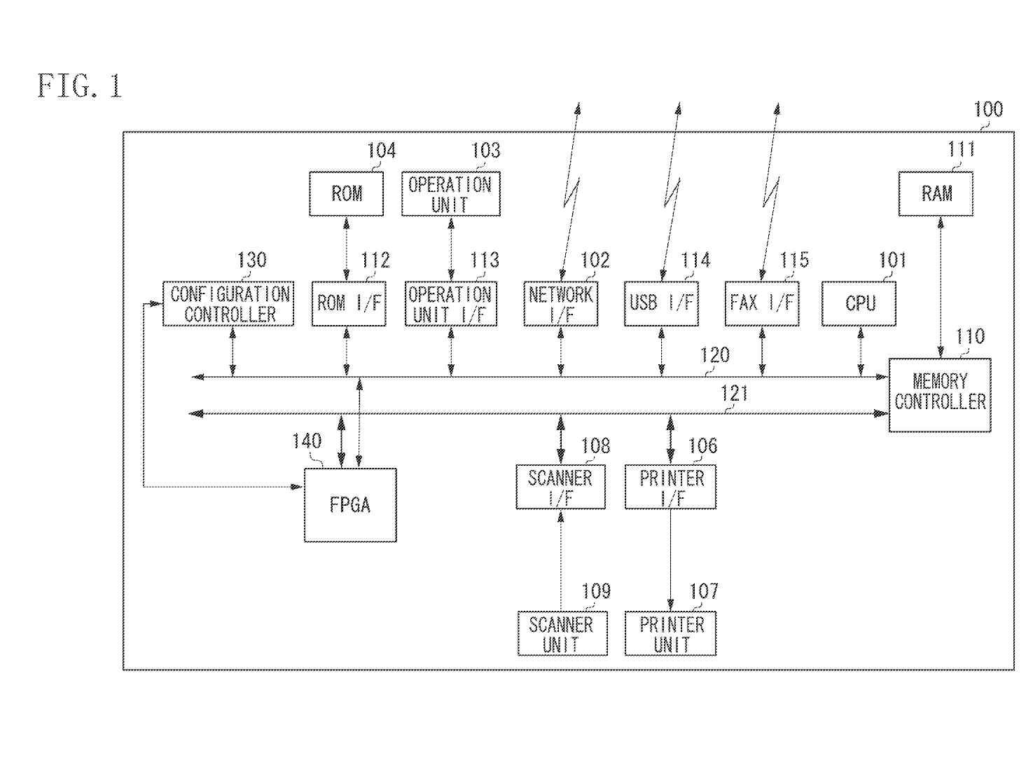

FIG. 1 illustrates an example of a hardware configuration of an image processing apparatus. An image processing apparatus 100 according to the present exemplary embodiment includes an operation unit 103, a scanner unit 109, and a printer unit 107 as a hardware configuration. A user of the image processing apparatus 100 performs various operations on the operation unit 103. The scanner unit 109 reads image information according to an instruction from the operation unit 103. The printer unit 107 prints image data on a sheet. The scanner unit 109 includes a central processing unit (CPU) for controlling the scanner unit 109, and an illumination lamp and a scanning mirror for reading a document. Similarly, the printer unit 107 includes a CPU for controlling the printer unit 107, a photosensitive drum for performing image formation, and a fixing unit for performing fixing.

The image processing apparatus 100 further includes a CPU 101 for totally controlling operations of the image processing apparatus 100, and a read only memory (ROM) 104 for storing programs to be executed by the CPU 101 and configuration data (logical circuit configuration information) to be used for configuration in an FPGA 140. The FPGA 140 is a dynamically and partially rewritable FPGA. More specifically, for example, while a circuit configured in a certain reconfiguration unit in the FPGA 140 is operating, the CPU 101 is able to reconfigure another circuit at another portion which does not overlap with the portion occupied by the operating circuit.

Although, in the present exemplary embodiment, an FPGA is described as an example of a reconfigurable device, a configurable device other than the FPGA may be connected to a bus of the image processing apparatus 100 as a hardware configuration of the image processing apparatus 100.

The image processing apparatus 100 includes a configuration controller 130 for controlling the configuration in the FPGA under control of the CPU 101.

The image processing apparatus 100 further includes a random access memory (RAM) 111 which serves as a system work memory required for operations of the CPU 101, and also as an image memory for temporarily storing image data. The image processing apparatus 100 further includes a memory controller 110 for controlling writing and reading of data to/from the RAM 111. The memory controller 110 is connected to a system bus 120 and an image bus 121, and controls access to the RAM 111.

The image processing apparatus 100 further includes a scanner interface (I/F) 108 for being input image data from the scanner unit 109 and a printer I/F 106 for outputting image data to the printer unit 107. The FPGA 140, the scanner I/F 108, and the printer I/F 106 are connected to the image bus 121 for transferring image data to be processed.

The image processing apparatus 100 performs communication (transmission and reception of data) with a general-purpose computer on a network via a network I/F 102. The image processing apparatus 100 further performs communication (transmission and reception of data) with a general-purpose computer connected with the image processing apparatus 100 via a universal serial bus (USB) I/F 114. The image processing apparatus 100 connects with a public line network via a FAX I/F 115, and performs communication (transmission and reception of data) with other image processing apparatuses and facsimile machines. The image processing apparatus 100 further includes a ROM I/F 112 for controlling reading of a program to be executed by the CPU 101 from the ROM 104. The image processing apparatus 100 further includes the system bus 120 for mutually connecting the CPU 101, the network I/F 102, the operation unit 103, the ROM I/F 112, the configuration controller 130, and the FPGA 140. The CPU 101 performs parameter setting on the FPGA 140, the scanner I/F 108, and the printer I/F 106 via the system bus 120.

Functions of the image processing apparatus 100 according to the present exemplary embodiment and processing of flowcharts (described below) are implemented when the CPU 101 performs processing based on a program stored in the ROM 104.

### [Configuration Related to Partial Reconfiguration]

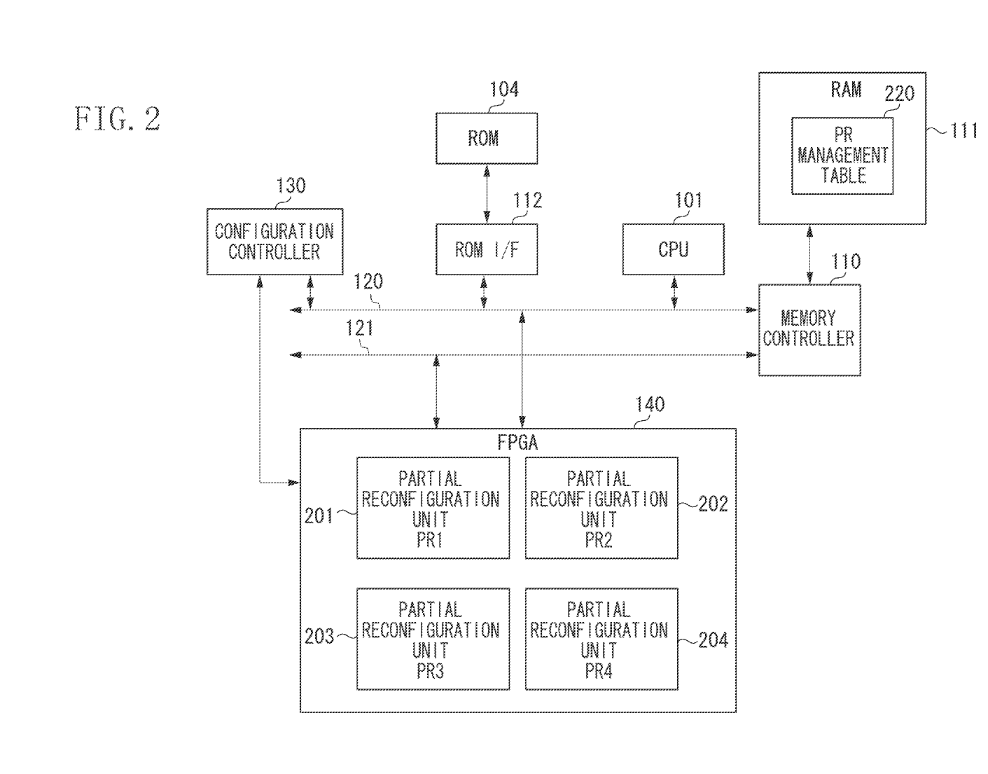

A configuration related to a partial reconfiguration in the image processing apparatus 100 according to the present exemplary embodiment will be described below with reference to FIG. 2. FIG. 2 illustrates a configuration particularly related to a partial reconfiguration in the image processing apparatus 100.

The CPU 101, the ROM 104, the ROM I/F 112, the memory controller 110, the RAM 111, the configuration controller 130, and the FPGA 140 have been described above with reference to FIG. 1.

The FPGA 140 includes a partial reconfiguration (PR) unit (PR1) 201, a partial reconfiguration unit (PR2) 202, a partial reconfiguration unit (PR3) 203, and a partial reconfiguration unit (PR4) 204. In each of the partial reconfiguration units 201 to 204, an image processing circuit is dynamically rewritable. Although, in the present specifications, the number of reconfigurable portions is 4 as an example, the configuration is not limited thereto.

The RAM 111 includes an area for a PR management table 220 (described below). The PR management table 220 includes information about the number of partial reconfiguration units included in the FPGA 140 and information about whether each of the partial reconfiguration units in the FPGA 140 is currently being used.

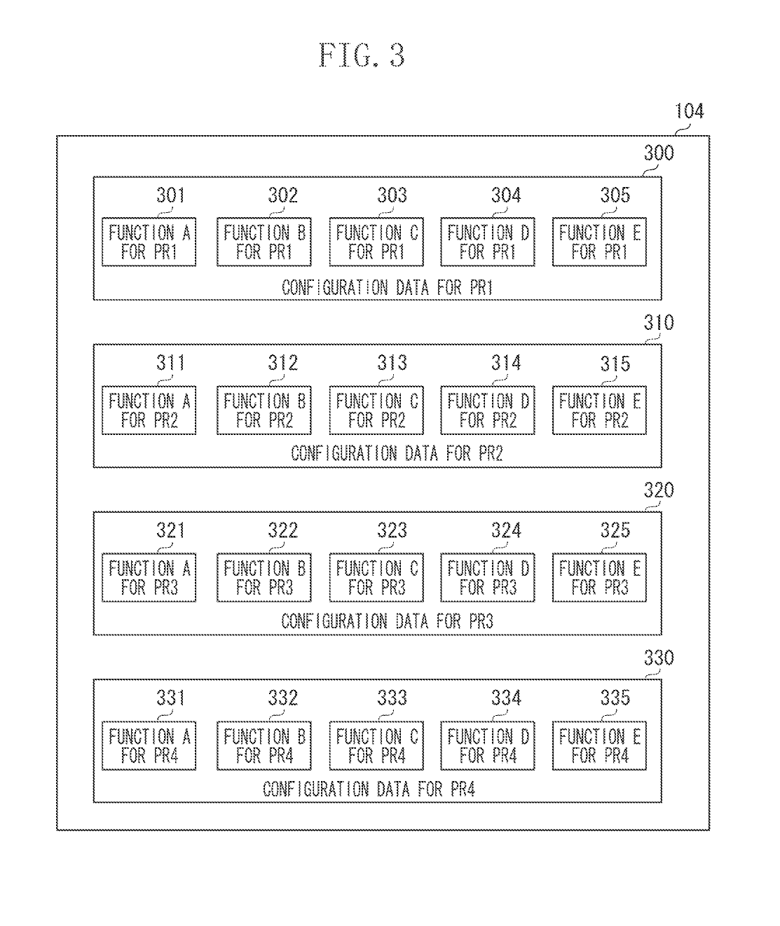

A method for storing configuration data related to the partial reconfiguration units 201 to 204 in the FPGA 140 in the image processing apparatus 100 according to the present exemplary embodiment will be described below with reference to FIG. 3.

FIG. 3 illustrates examples of configuration data stored in the ROM 104, to be configured in each of the partial reconfiguration units 201 to 204 in the FPGA 140.

The ROM 104 stores a plurality of pieces of configuration data required for a partial reconfiguration. Configuration data (for PR1) 300 indicates configuration data reconfigurable in the partial reconfiguration unit (PR1) 201. FIG. 3 illustrates an example of a case where five functions (A, B, C, D, and E) are reconfigurable in the partial reconfiguration unit (PR1) 201. Configuration data 301 is configuration data for implementing the configuration of the function A in the partial reconfiguration unit (PR1) 201. Configuration data 302 indicates configuration data for implementing the configuration of the function B in the partial reconfiguration unit (PR1) 201. Configuration data 303 indicates configuration data for implementing the configuration of the function C in the partial reconfiguration unit (PR1) 201. Configuration data 304 indicates configuration data for implementing the configuration of the function D in the partial reconfiguration unit (PR1) 201. Configuration data 305 indicates configuration data for implementing the configuration of the function E in the partial reconfiguration unit (PR1) 201.

Configuration data (for PR2) 310 indicates configuration data reconfigurable in the partial reconfiguration unit (PR2) 202. The configuration data (for PR2) 310 also stores configuration data for the five functions (A, B, C, D, and E). For example, the CPU 101 is able to selectively configure the five functions in the partial reconfiguration unit (PR2) 202.

Configuration data (for PR3) 320 indicates configuration data reconfigurable in the partial reconfiguration unit (PR3) 203. The configuration data (for PR3) 320 also stores configuration data for the five functions (A, B, C, D, and E). For example, the CPU 101 is able to selectively configure the five functions in the partial reconfiguration unit (PR3) 203.

Configuration data (for PR4) 330 indicates configuration data reconfigurable in the partial reconfiguration unit (PR4) 204. The configuration data (for PR4) 330 also stores configuration data for the five functions of (A, B, C, D, and E). For example, the CPU 101 is able to selectively configure the five functions in the partial reconfiguration unit (PR4) 204.

As described above, the image processing apparatus 100 needs to prepare configuration data for each partial reconfiguration unit. For example, to implement the configuration of the function A in the partial reconfiguration unit (PR1) 201 and the partial reconfiguration unit (PR2) 202, it is necessary to prepare different configuration data for each configuration location even in a case where the same function, such as the configuration data 301 and 311, is to be implemented.

Although, in the present exemplary embodiment, the configuration data 300 to 330 is stored in the ROM 104, the configuration data may be stored in a nonvolatile storage such as a hard disk of the image processing apparatus 100 or a server on a network. More specifically, the configuration data 300 to 330 may be stored in any location as long as the CPU 101 is able to read the configuration data.

### [PR Management Table]

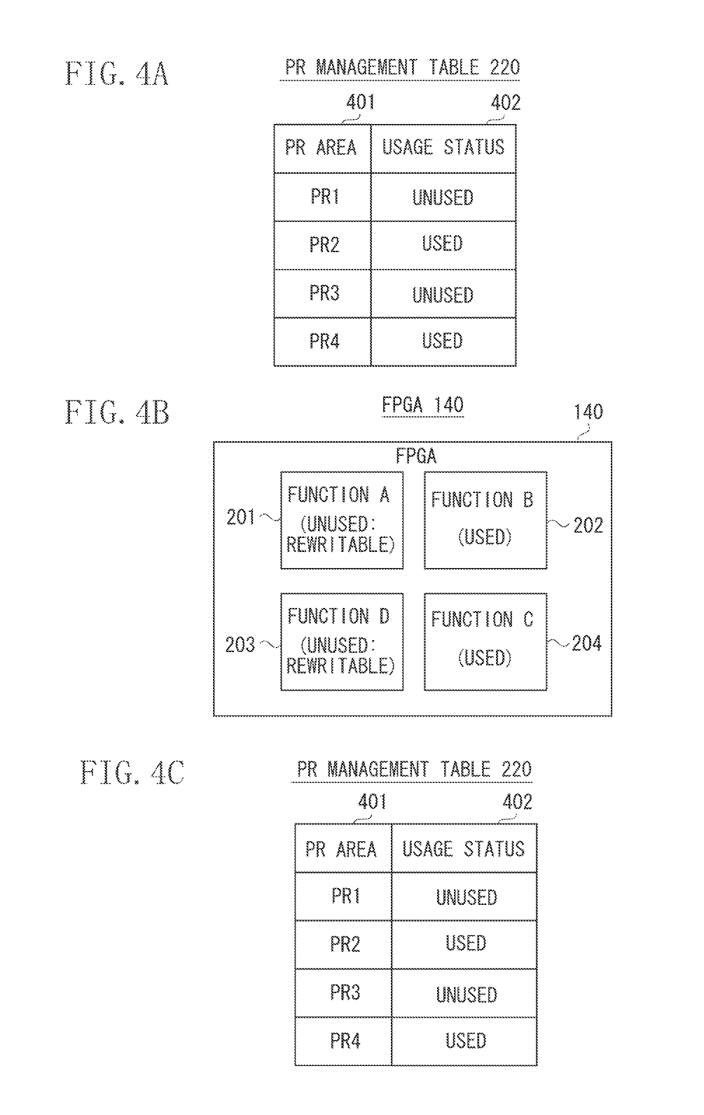

FIGS. 4A to 4C illustrate examples of contents of the PR management table 220 and usage statuses in the FPGA 140.

FIG. 4A illustrates contents of the PR management table 220.

FIG. 4B illustrates an example of the usage statuses of the partial reconfiguration units 201 to 204 in the FPGA 140, and FIG. 4C illustrates an example of the contents of the PR management table 220 corresponding to the case of FIG. 4B.

The PR management table 220 will be described below with reference to FIG. 4A.

A PR area 401 is an item which indicates the number of partially reconfigurable areas included in the FPGA 140. The example according to the present exemplary embodiment indicates that the FPGA 140 includes four different partially reconfigurable areas: the partial reconfiguration unit (PR1) 201, the partial reconfiguration unit (PR2) 202, the partial reconfiguration unit (PR3) 203, and the partial reconfiguration unit (PR4) 204.

A usage status 402 indicates usage statuses of the partial reconfiguration units 201 to 204 (“Used” or “Unused”). In processing of flowcharts (described below), the CPU 101 rewrites the usage statuses depending on the usage status of each partial reconfiguration unit.

When the CPU 101 performs a partial reconfiguration, the CPU 101 uses the usage status 402 to determine which area out of the partial reconfiguration units 201 to 204 is not used (operating).

The area of each partial reconfiguration unit (or a PR area to be described below) is an example of a partial reconfiguration unit area. The usage status is an example of use state information.

An example of usage statuses of the partial reconfiguration units 201 to 204 in the FPGA 140, and an example of contents of the PR management table 220 corresponding thereto will be described below with reference to FIGS. 4B and 4C.

FIG. 4B illustrates a state where configuration data for the function B is configured in the partial reconfiguration unit 202 in the FPGA 140 and configuration data for the function C is configured in the partial reconfiguration unit 204 in the FPGA 140, and where the CPU 101 is performing processing by using the partial reconfiguration units 202 and 204. FIG. 4B illustrates that the partial reconfiguration units 201 and 203 in the FPGA 140 are not currently being used by the CPU 101, and therefore are rewritable areas. However, once configuration is performed in a partial reconfiguration unit, reconfigured circuit information (configuration data) at the time of configuration is retained in the partial reconfiguration unit even if it is not currently being used. In the example according to the present exemplary embodiment, the configuration data 301 for the function A is configured in the partial reconfiguration unit 201, and configuration data 324 for the function D is configured in the partial reconfiguration unit 203.

FIG. 4C illustrates the contents of the PR management table 220 when the statuses in the FPGA 140 are as illustrated in FIG. 4B. A status indicating “Used” or “Unused” is stored for each PR area under control of the CPU 101. In the example illustrated in FIG. 4C, the PR2 and the PR4 areas are currently being used (“Used”), and the PR1 and the PR3 areas are not currently being used (“Unused”).

Information processing for determining an unused area and writing configuration data by using the PR management table 220 will be described below.

### [Information Processing]

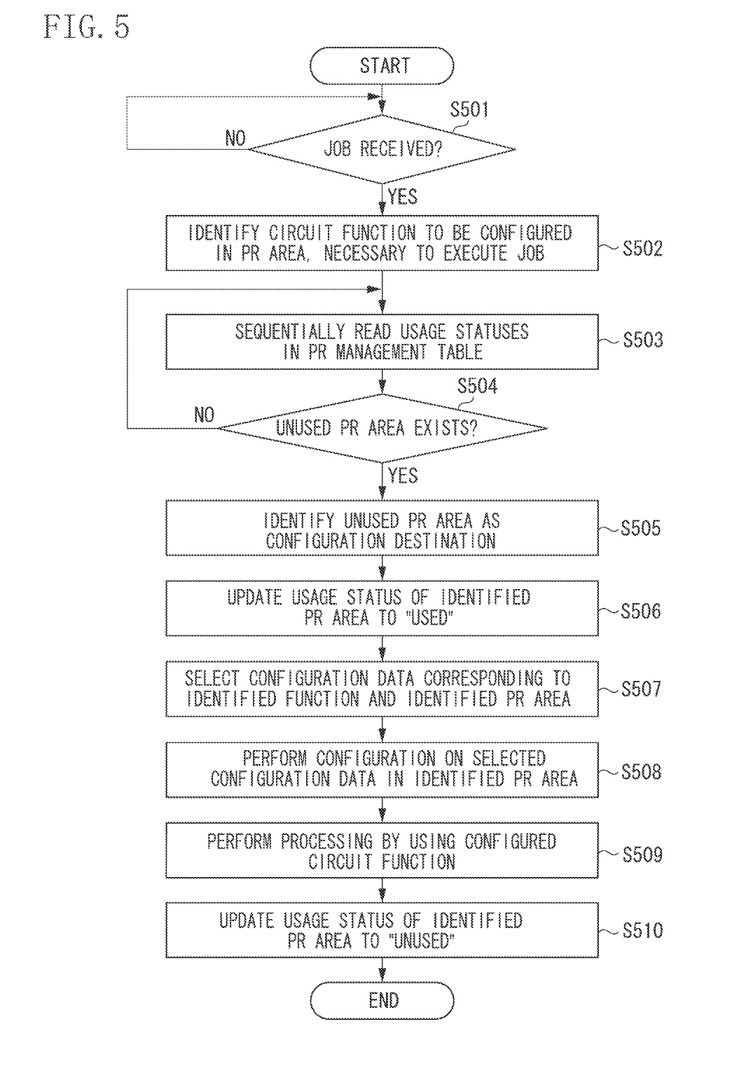

FIG. 5 is a flowchart illustrating an example of information processing by the image processing apparatus 100. The CPU 101 is also able to perform processing of this flowchart in parallel for each job. The flowchart will be described below on the assumption that the partial reconfiguration units 201 to 204 are PR areas.

In step S501, the CPU 101 determines whether a job is received. When the CPU 101 receives a job (YES in step S501), the processing proceeds to step S502. On the other hand, when the CPU 101 does not receive a job (NO in step S501), the processing returns to step S501.

In step S502, before executing the received job, the CPU 101 identifies a function which needs to be configured in the FPGA 140. For example, a function required for each job is preset in the ROM 104 as setting information. Based on the received job and the above-described setting information, the CPU 101 identifies a function corresponding to the received job. For example, to process the received job, the CPU 101 identifies whether a circuit for implementing the function A needs to be configured in a PR area.

In step S503, the CPU 101 sequentially reads the usage statuses 402 in the PR management table 220 stored in the RAM 111.

In step S504, the CPU 101 determines whether an unused PR area exists based on the result of the status reading in step S503. When the CPU 101 determines that an unused partial reconfiguration (PR) area exists (YES in step S504), the processing proceeds to step S505. On the other hand, when the CPU 101 determines that no unused partial reconfiguration (PR) area exists (NO in step S504), the processing returns to step S503.

In step S505, the CPU 101 identifies the detected unused PR area as a configuration destination.

In step S506, the CPU 101 updates the usage status 402 in the PR management table 220 corresponding to the unused PR area identified in step S505. More specifically, the CPU 101 changes the relevant usage status 402 from “Unused” to “Used.” This processing enables preventing other jobs currently being executed in parallel from incorrectly configuring data in partial reconfiguration areas currently being used.

In step S507, the CPU 101 selects the configuration data corresponding to the function identified in step S502 and the PR area identified in step S505.

In step S508, the CPU 101 reads the configuration data selected in step S507 from the ROM 104, and performs configuration with the configuration data. The processing in step S508 is an example of control processing for controlling processing for writing configuration data to a destination partial reconfiguration unit area.

In step S509, the CPU 101 executes the job by using the configured circuit function. The processing in step S509 includes register setting for circuit activation, end interruption wait processing, end interruption handling processing, and so on.

Upon completion of processing of the job that used the configured function, then in step S510, the CPU 101 updates the usage status 402 in the PR management table 220 corresponding to the PR area identified in step S505 from “Used” to “Unused.” At this timing, other jobs currently being executed in parallel are able to use the relevant PR area.

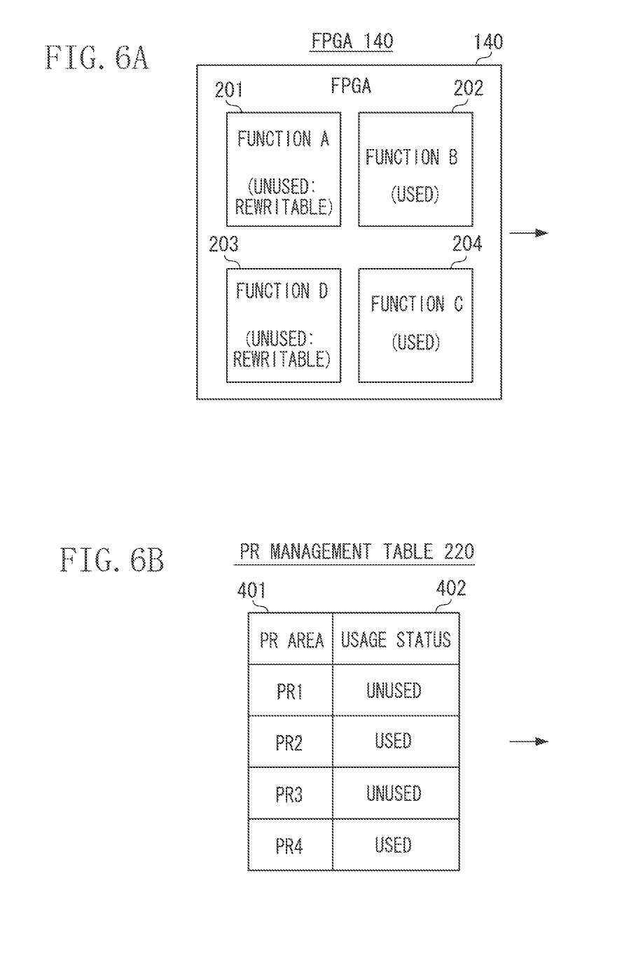

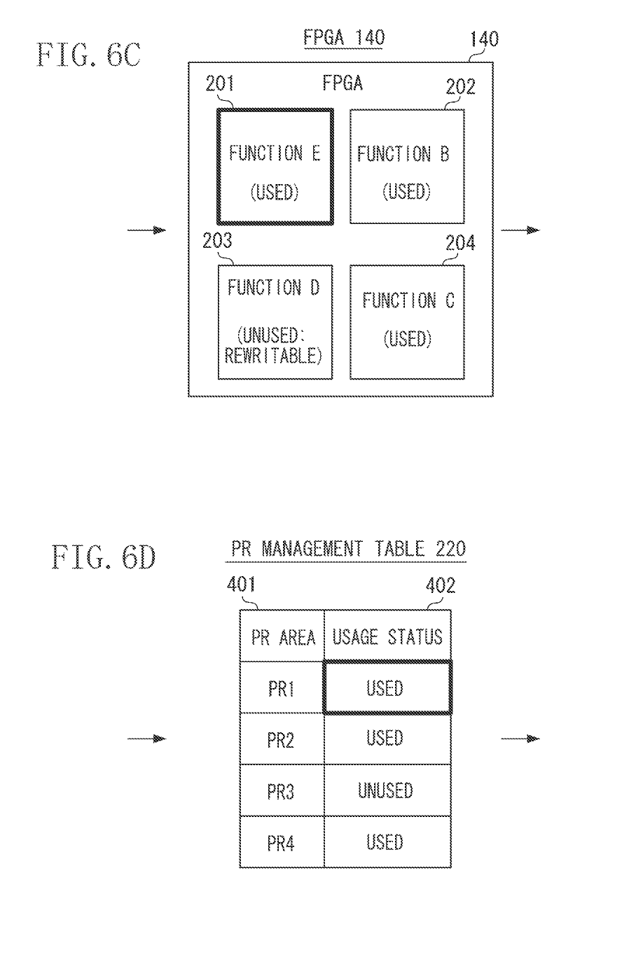

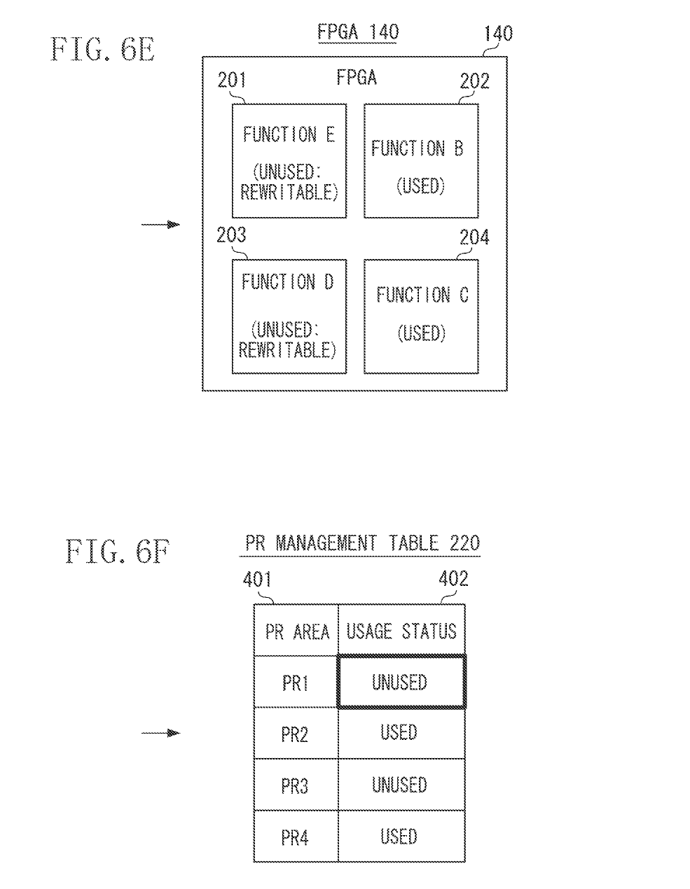

Operations related to the flowchart illustrated in FIG. 5 will be described in detail below with reference to FIGS. 6A to 6F. An example according to the present exemplary embodiment will be described below on the premise that the CPU 101 receives a job, determines that the function E is required, reconfigures the configuration data for the function E in the FPGA 140, and ends job processing. Referring to FIGS. 6C, 6D, and 6F, the portions drawn with bold lines are changed portions.

FIGS. 6A and 6B illustrate the statuses in the FPGA 140 and the contents of the PR management table 220 before a job is received in step S501.

FIGS. 6C and 6D illustrate the statuses in the FPGA 140 and the contents of the PR management table 220 after the CPU 101 has configured the function E in the FPGA 140 in steps from S502 to S508.

In step S502, the CPU 101 identifies that the function E is required. In steps S503 and S504, the CPU 101 confirms that the PR1 and the PR3 areas are not used. In step S505, the CPU 101 determines to write the configuration data for the function E to the partial reconfiguration unit (PR1) 201. In step S506, the CPU 101 updates the usage status 402 indicating the usage status of the PR1 area (the partial reconfiguration unit 201) to “Used.” In step S507, the CPU 101 selects the configuration data 305 which is configuration data for the function E for the PR1 area (the partial reconfiguration unit 201). In step S508, the CPU 101 configures the configuration data 305 in the PR1 area (the partial reconfiguration unit 201).

FIGS. 6E and 6F illustrate the statuses in the FPGA 140 and the contents of the PR management table 220 after the CPU 101 has completed processing of the job which used the function E in steps S509 and S510.

In step S509, the CPU 101 executes the job in which the function E is used. Upon completion of such job execution, then in step S510, the CPU 101 updates the usage status 402 indicating the usage status of the PR1 area (the partial reconfiguration unit 201) to “Unused.”

As described above, according to the processing of the present exemplary embodiment, unused areas are confirmed and a partial reconfiguration (configuration) is performed in the image processing apparatus 100 having reconfigurable circuits. Therefore, a partial reconfiguration function can be used without suspending processing currently being executed.

In the above-described control method according to the first exemplary embodiment, one system including a CPU uses one FPGA 140.

The following assumes a case where a plurality of systems uses one FPGA 140. When a plurality of systems uses one FPGA 140, a communication interface protocol for enabling communication between the systems and confirming which of the partial reconfiguration units 201 to 204 is an unused area is required.

A second exemplary embodiment will be described below based on an example case where a function equivalent to the usage status 402 in the PR management table 220 is included in configuration data. With this configuration, even when a plurality of systems uses one FPGA 140, a plurality of the systems is able to use the FPGA 140 on an individual basis.

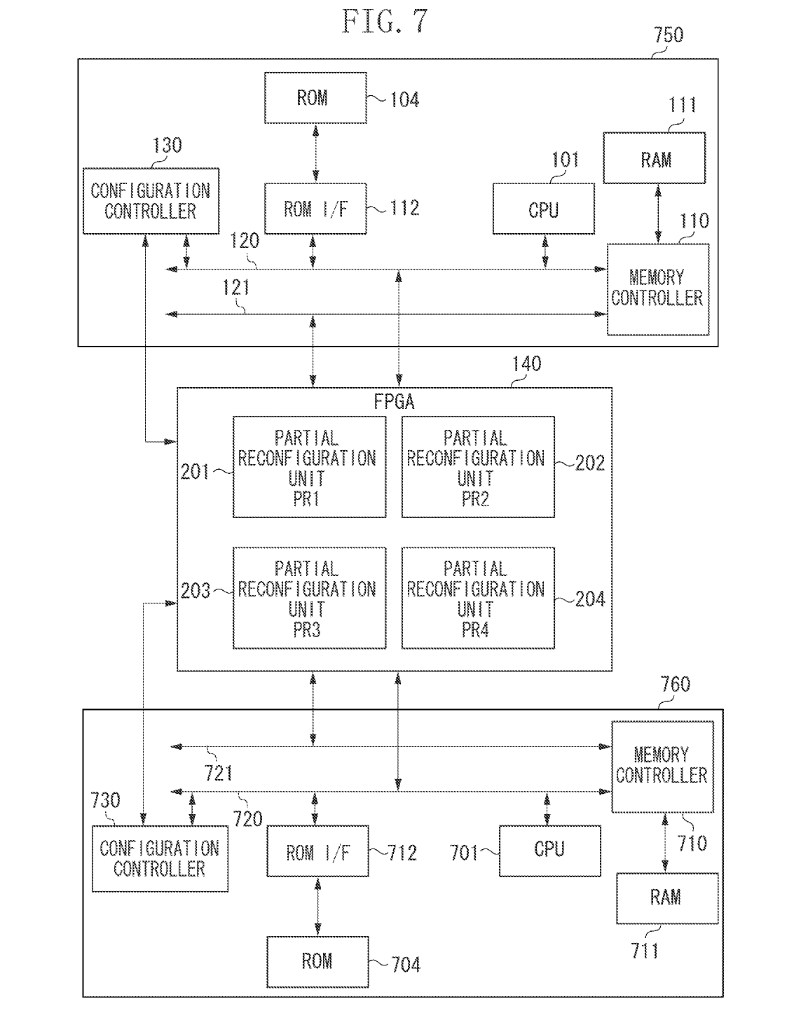

FIG. 7 illustrates an example of a system configuration and a hardware configuration in a case where two systems, each including a CPU respectively, control one FPGA 140 according to the present exemplary embodiment.

Differences from the configuration illustrated in FIG. 2 will be mainly described below. A first system (or the first image processing apparatus) 750 includes hardware components 101 to 130. A second system (or a second image processing apparatus) 760 includes hardware components 701 to 730. The hardware components 701 to 730 are considered to have a similar configuration to the hardware components 101 to 130. The first system 750 and the second system 760 are respectively connected to the FPGA 140, and are able to perform configuration and control on the partial reconfiguration units 201 to 204.

Functions of the first system (or the first image processing apparatus) 750 according to the present exemplary embodiment and processing of a flowchart (described below) related to the first system 750 are implemented when the CPU 101 performs processing based on a program stored in the ROM 104. Further, functions of the second system (or the second image processing apparatus) 760 according to the present exemplary embodiment and processing of the flowchart (described below) related to the second system 760 are implemented when a CPU 701 performs processing based on a program stored in the ROM 704.

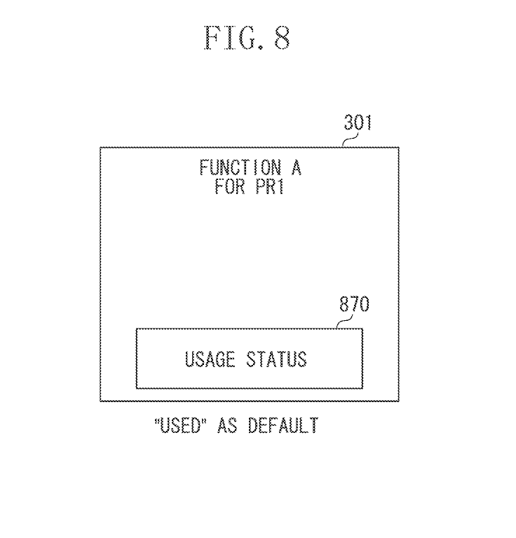

FIG. 8 illustrates that configuration data for each partial reconfiguration unit includes an area for managing a usage status 870.

In the example according to the present exemplary embodiment, the usage status 870 is implemented in the configuration data 301 for the function A for PR1. The first system 750 and the second system 760 need to generate configuration data in which the usage status 870 is implemented.

The usage status 870 can be respectively accessed from both the CPU 101 of the first system 750 and the CPU 701 of the second system 760. In the present exemplary embodiment, the usage status 870 is used in a similar way to the usage status 402 managed on the RAM 111 by the CPU 101 according to the first exemplary embodiment. The usage status 870 differs from the usage status 402 in that it can be respectively accessed from both the CPU 101 of the first system 750 and the CPU 701 of the second system 760 and that it controls whether the partial reconfiguration units 201 to 204 are “Used” or “Unused.” It is more preferable to set the usage status 870 to “Used” as an initial setting value.

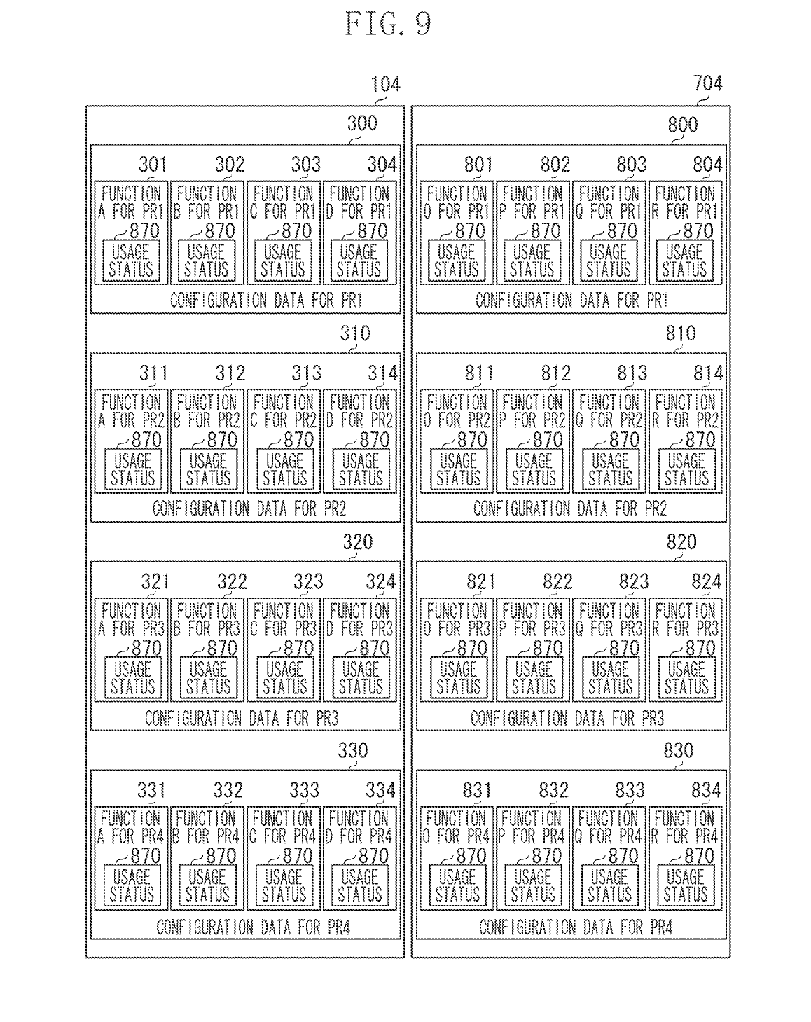

FIG. 9 illustrates examples of configuration data stored in the ROM 104 in the first system 750 illustrated in FIG. 7, and examples of configuration data stored in the ROM 704 in the second system 760 illustrated in FIG. 7.

Configuration data required to execute a job in the first system 750 relates four functions (A, B, C, and D). The configuration data 300 to 330 respectively corresponding to the four partial reconfiguration units 201 to 204 is stored in the ROM 104.

Configuration data required to execute a job in the second system 760 relates four functions (O, P, Q, and R). Configuration data 800 to 830 respectively corresponding to the four partial reconfiguration units 201 to 204 is stored in the ROM 704.

Each piece of configuration data includes the usage status 870 illustrated in FIG. 8.

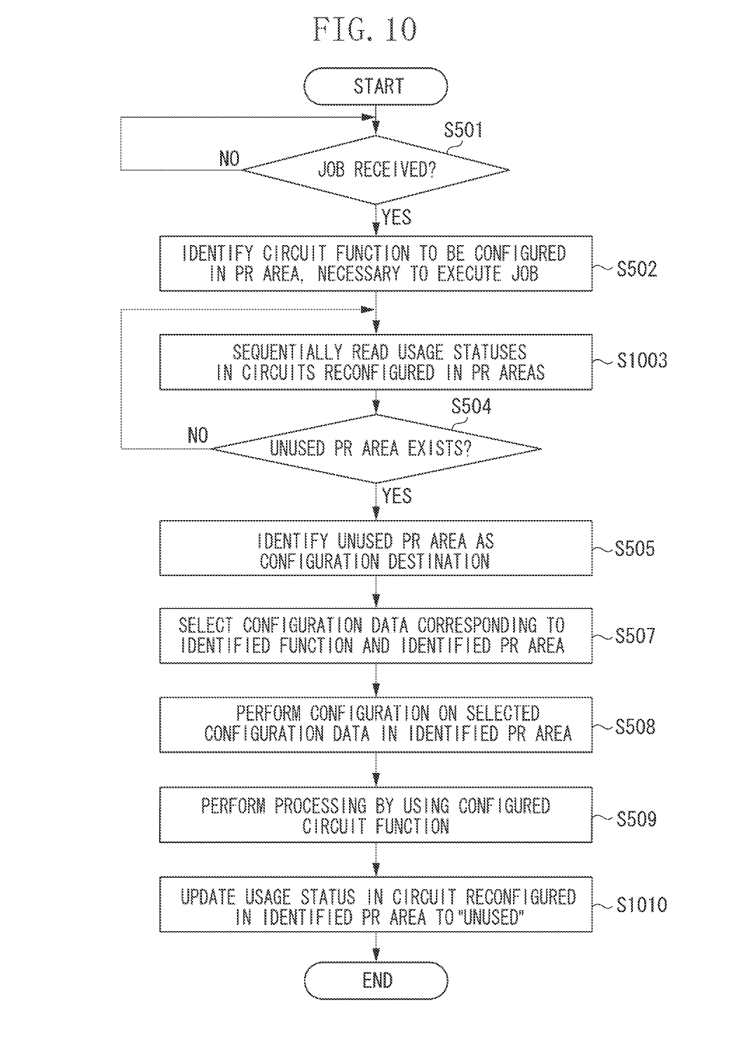

FIG. 10 is a flowchart illustrating an example of information processing performed by the image processing apparatus 100. Differences from the flowchart illustrated in FIG. 5 will be mainly described below. The CPU 101 and the CPU 701 are able to perform processing of this flowchart in parallel for each job.

Processing in steps S501, S502, S504, S505, S507, S508, and S509 illustrated in FIG. 10 is equivalent to the processing in the same steps, respectively, illustrated in FIG. 5, and descriptions thereof will be omitted. However, when the first system (or the first image processing apparatus) 750 is performing processing, each step is performed by the CPU 101. On the other hand, when the second system (or the second image processing apparatus) 760 is performing processing, each step is performed by the CPU 701. To simplify descriptions, the flowchart illustrated in FIG. 10 will be described below on the premise that the processing is performed by the second system 760.

In step S1003, the CPU 701 sequentially reads the usage statuses 870 in the partially reconfigured circuits configured in the PR1 to PR4 areas in the FPGA 140.

In step S1010, the CPU 701 updates the usage status 402 corresponding to the PR area identified in step S505 from “Used” to “Unused.” At this timing, other jobs currently being executed in parallel are able to use the PR area.

The reason why the flowchart illustrated in FIG. 10 does not include the processing for updating the usage status equivalent to step S506 of the flowchart illustrated in FIG. 5 will be described below. In the present exemplary embodiment, the usage status 870 in a reconfigured circuit portion becomes “Used”, when configuration is completed in step S508.

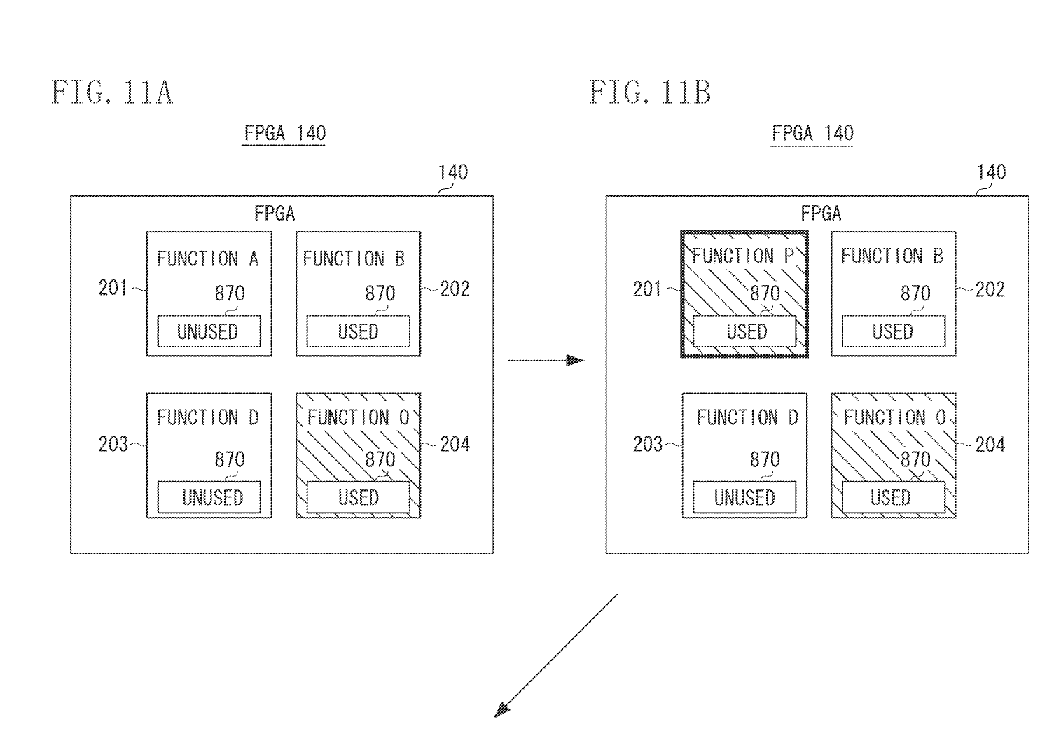

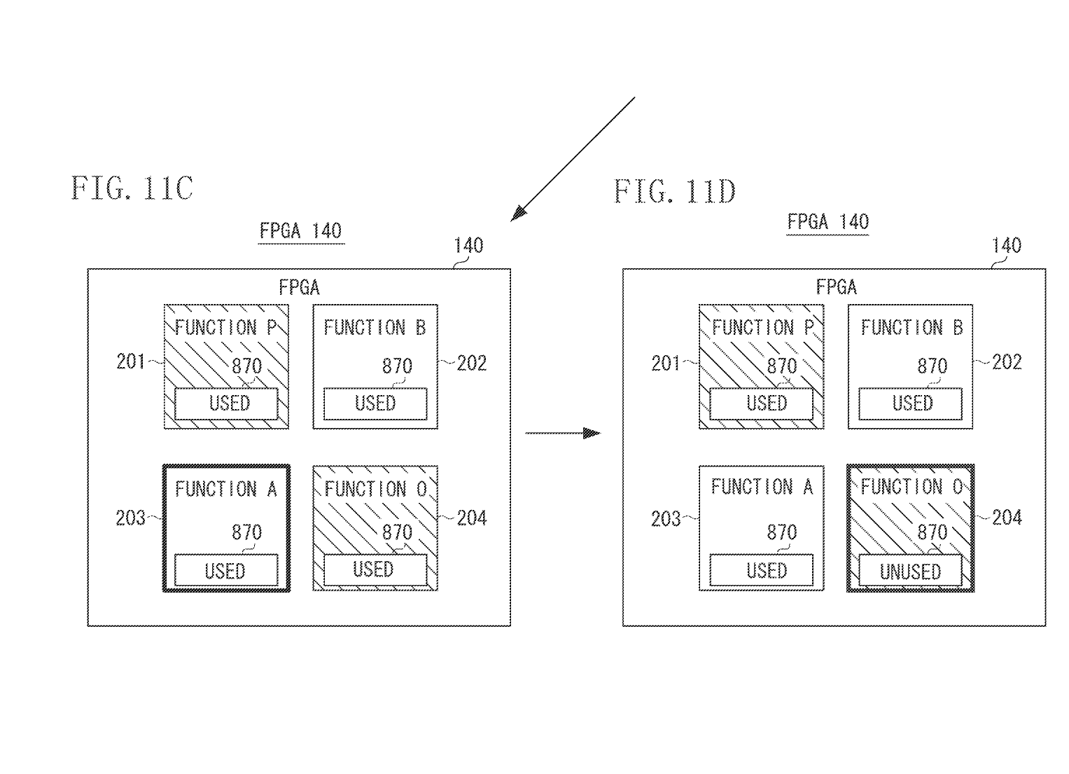

Operations of the flowchart illustrated in FIG. 10 will be described in detail below with reference to FIGS. 11A to 11D. An example according to the present exemplary embodiment will be described below on the following premise. First of all, the CPU 701 of the second system 760 reconfigures the configuration data for the function P in the FPGA 140. Next, the CPU 101 of the first system 750 reconfigures the configuration data for the function A in the FPGA 140. Then, the CPU 701 of the second system 760 completes execution of a job that used the partial reconfiguration unit (PR4) 204 in the FPGA 140. Referring to FIGS. 11A to 11D, portions drawn with bold lines are changed portions, and shaded PR areas are circuits configured by the second system 760.

FIG. 11A illustrates the usage statuses 870 in the FPGA 140 at a certain timing.

FIG. 11B illustrates the statuses 870 in the FPGA 140 after the CPU 701 of the second system 760 received a job that is to use the function P and configured the function P in the FPGA 140.

In step S502, the CPU 701 of the second system 760 identifies that the function P is required. In steps S1003 and S504, the CPU 701 confirms that the PR1 and PR3 areas are not used. In step S505, the CPU 701 determines to write configuration data for the function P in the partial reconfiguration unit (PR1) 201. In step S507, the CPU 701 selects the configuration data 802 which is configuration data for the function P for the PR1 area (the partial reconfiguration unit 201). In step S508, the CPU 701 performs configuration on the PR1 area (the partial reconfiguration unit 201).

FIG. 11C illustrates the statuses 870 in the FPGA 140 after the CPU 101 of the first system 750 received a job that is to use the function A and configured the function A in the FPGA 140, in the state illustrated in FIG. 11B.

In step S502, the CPU 101 of the first system 750 identifies that the function A is required. In steps S1003 and S504, the CPU 101 confirms that the PR3 area is not used. In step S505, the CPU 101 determines to write configuration data for the function A in PR3 area. In step S507, the CPU 101 selects the configuration data 321 which is configuration data for the function A for the PR3 area (the partial reconfiguration unit 203). In step S508, the CPU 101 performs configuration on the PR3 area (the partial reconfiguration unit 203).

FIG. 11D illustrates the statuses 870 in the FPGA 140 after the CPU 701 of the second system 760 completed a job that used the function O, in the state illustrated in FIG. 11C.

In step S509, the CPU 701 of the second system 760 ends processing of the job that used the function 0. In step S1010, the CPU 701 updates the usage status 870 of the PR4 area to “Unused.”

As described above, according to the processing of the present exemplary embodiment, even when a plurality of systems uses one FPGA 140, a plurality of the systems is able to use the FPGA 140 on an individual basis.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-described exemplary embodiments, the partial reconfiguration function can be used without suspending a function currently being processed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-158700, filed Aug. 4, 2014, which is hereby incorporated by reference herein in its entirety.

What is claimed is:

1. An image processing apparatus comprising:
an identification unit configured to identify a circuit function required to execute a job;
a reading unit configured to read use state information of partial reconfiguration unit areas;
a determination unit configured to determine an unused partial reconfiguration unit area as a writing destination based on the use state information read by the reading unit;
a selection unit configured to select configuration data based on both the circuit function identified by the identification unit and the partial reconfiguration unit area determined as a writing destination by the determination unit; and
a control unit configured to control processing for writing the configuration data selected by the selection unit to the partial reconfiguration unit area determined as a writing destination.

2. The image processing apparatus according to claim 1, further comprising a receiving unit configured to receive a job,
wherein the identification unit identifies a circuit function corresponding to the job received by the receiving unit.

3. The image processing apparatus according to claim 1, further comprising another control unit configured to control execution of processing related to the job by using a circuit function for a partial reconfiguration unit in which the configuration data was written to the partial reconfiguration unit area by a writing unit.

4. The image processing apparatus according to claim 1, further comprising an updating unit configured to update the use state information of the partial reconfiguration unit area determined as a writing destination by the determination unit to “Used.”

5. The image processing apparatus according to claim 3, further comprising an updating unit configured to, when the processing related to the job is completed, update the use state information of the partial reconfiguration unit area determined as a writing destination by the determination unit to “Unused.”

6. The image processing apparatus according to claim 1, wherein the reading unit reads the use state information from a management table for storing use state information of the partial reconfiguration unit areas.

7. The image processing apparatus according to claim 1, wherein the reading unit reads the use state information from configuration data corresponding to the circuit function and the partial reconfiguration unit area.

8. A system including a first image processing apparatus and a second image processing apparatus capable of accessing partial reconfiguration units, wherein each of the first and the second image processing apparatuses comprises:
an identification unit configured to identify a circuit function required to execute a job;
a reading unit configured to read use state information of partial reconfiguration unit areas;
a determination unit configured to determine an unused partial reconfiguration unit area as a writing destination based on the use state information read by the reading unit;
a selection unit configured to select configuration data based on both the circuit function identified by the identification unit and the partial reconfiguration unit area determined as a writing destination by the determination unit; and
a control unit configured to control processing for writing the configuration data selected by the selection unit to the partial reconfiguration unit area determined as a writing destination.

9. An information processing method performed by an image processing apparatus, the information processing method comprising:
identifying a circuit function required to execute a job;
reading use state information of partial reconfiguration unit areas;
determining an unused partial reconfiguration unit area as a writing destination based on the read use state information;
selecting configuration data based on both the identified circuit function and the partial reconfiguration unit area determined as a writing destination; and
controlling processing for writing the selected configuration data to the partial reconfiguration unit area determined as a writing destination.
